(19) United States
(12) Patent Application Publication
(10) Pub. No.: US 2024/0330158 A1
(43) Pub. Date: Oct. 3, 2024

(54) ELECTRONIC DEVICE, GENERATION METHOD FOR SOFTWARE CODE AND ANALYZATION METHOD FOR TEST COVERAGE

(71) Applicant: Samsung Electronics Co., Ltd., Suwon-si (KR)

(72) Inventors: Wonchol KIM, Suwon-si (KR); Taeyong KIM, Suwon-si (KR); Jiwon PARK, Suwon-si (KR); Moonwook OH, Suwon-si (KR); Jaegyu CHOI, Suwon-si (KR)

(73) Assignee: Samsung Electronics Co., Ltd., Suwon-si (KR)

(21) Appl. No.: 18/537,632

(22) Filed: Dec. 12, 2023

(30) Foreign Application Priority Data
Mar. 27, 2023 (KR) 10-2023-0039580

(51) Int. Cl. G06F 11/36

(52) U.S. Cl. CPC G06F 11/3676; G06F 11/3688

(57) ABSTRACT

An electronic device includes: a memory in which software code, including a plurality of test positions is loaded; and a processor configured to execute the software code in order according to a control flow, wherein the processor is configured to allocate a test coverage data region in the memory, execute the software code based on a test scenario, when an execution position reaches a target test position among the plurality of test positions, mark a memory position corresponding to the target test position in the test coverage data region in response to a test coverage marking instruction associated with the target test position, and output test coverage data of the test coverage data region in response to an external command.

### CROSS-REFERENCE TO RELATED APPLICATION(S)

This application claims benefit of priority to Korean Patent Application No. 10-2023-0039580 filed on Mar. 27, 2023, in the Korean Intellectual Property Office, the disclosure of which is incorporated herein by reference in its entirety.

### BACKGROUND

The present disclosure relates to an electronic device for executing software, a generation method for software code of the electronic device, and an analyzation method for a test coverage of the software.

Real-time responsiveness and stability in embedded systems are becoming essential. Sufficient tests are desired to ensure the real-time responsiveness and stability of embedded software, and the test results may be derived by executing a plurality of test scenarios in the software and analyzing a test coverage as an execution result. The test coverage is a measure of the degree to which software code has been tested, and may be determined by a proportion of the number of actual test targets, such as a statement and a function of the software code, to the total number of test targets.

On the other hand, since the embedded software operates in an environment in which system resources may be (for example, severely) constrained, an operation of analyzing the test coverage can cause a larger overhead on the embedded system.

### SUMMARY

An aspect of the present disclosure is to provide an electronic device for updating test coverage data during runtime in which software is being tested and providing the test coverage data to an external analysis device, and an analyzation method for a test coverage.

According to an aspect of the present disclosure, provided is a generation method for software code that can effectively test software even in an embedded system by reducing an overhead for updating test coverage data.

According to an aspect of the present disclosure, an electronic device includes: a memory in which software code, including a plurality of test positions is loaded; and a processor configured to execute the software code in order according to a control flow, wherein the processor is configured to allocate a test coverage data region in the memory, execute the software code based on a test scenario, when an execution position reaches a target test position among the plurality of test positions, mark a memory position corresponding to the target test position in the test coverage data region in response to a test coverage marking instruction associated with the target test position, and output test coverage data of the test coverage data region in response to an external command.

According to an aspect of the present disclosure, a generation method for software code includes: obtaining a source file indicating to allocate a determined region in a memory of an electronic device in which the software code is executed, to a test coverage data region; generating a binary file by compiling the source file and generating debugging information associated with the binary file; performing a control flow analysis on the binary file using the debugging information; determining a test position for each of at least some of a plurality of basic blocks determined according to the control flow analysis; and inserting an instruction of instructing a memory position corresponding to the test position to be marked in the test coverage data region, into the test position of the binary file.

According to an aspect of the present disclosure, an analyzation method for a test coverage includes: installing software code including a plurality of test positions determined based on control flow analysis and when a target test position among the plurality of test positions is executed, instructing to mark a memory position corresponding to the target test position in an allocated memory region, in an electronic device; providing a command to the electronic device according to a test scenario; obtaining test coverage data of the allocated memory region from the electronic device; and analyzing a test coverage using the test coverage data and metadata indicating of a mapping information between a plurality of memory positions of the test coverage data and the plurality of test positions.

An electronic device and an analyzation method for a test coverage according to example embodiments of the present disclosure may generate test coverage data during a runtime in which software is being tested, by updating test performance result data at a test position to a previously allocated memory region.

A generation method for software code according to example embodiments of the present disclosure may reduce an overhead for updating test coverage data by inserting an instruction of updating test performance result data into a binary code of software.

Advantages and effects of the present application are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view illustrating an electronic system according to example embodiments of the present disclosure;

FIG. 2 is a view illustrating a control flow graph (CFG) of software;

FIG. 3 is a view illustrating an operation of an electronic system according to example embodiments of the present disclosure;

FIG. 4 is a flowchart illustrating a generation method for software code according to example embodiments of the present disclosure;

FIG. 5 is a view illustrating software code generated according to example embodiments of the present disclosure;

FIG. 6 is a flowchart illustrating an operation of an electronic device according to example embodiments of the present disclosure;

FIG. 7 is a view illustrating an operation of an electronic device according to example embodiments of the present disclosure;

FIG. 8 is a flowchart illustrating an analyzation method for a test coverage according to example embodiments of the present disclosure;

FIG. 9 is a view illustrating an analyzation method for a test coverage according to example embodiments of the present disclosure; and

FIGS. 10A to 10C are views illustrating an analyzation method for a test result according to example embodiments of the present disclosure.

### DETAILED DESCRIPTION

Hereinafter, example embodiments of the present disclosure will be described with reference to the accompanying drawings.

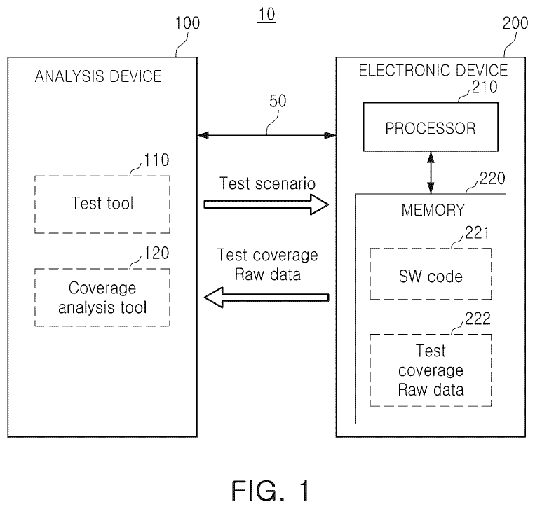

FIG. 1 is a view illustrating an electronic system according to example embodiments of the present disclosure.

Referring to FIG. 1, an electronic system 10 may include an analysis device 100 and an electronic device 200.

The electronic device 200 may include an embedded system. For example, the electronic device 200 may be a memory system such as a solid state drive (SSD). However, the electronic device 200 is not limited to the memory system, and may be a smartphone, a digital camera, an automobile system, an industrial control system, etc.

The electronic device 200 may execute embedded software. The embedded software may include firmware and a real-time operating system (RTOS). The embedded software may be stored in a nonvolatile memory such as a flash memory of the electronic device 200 or an electrically erasable programmable read-only memory (EEPROM), and may be maintained even when the electronic device 200 is powered off.

The electronic device 200 may include a processor 210 and a memory 220. In the memory 220, software codes for executing the embedded software may be loaded from the nonvolatile memory. For example, the memory 220 may be implemented as a volatile memory such as a static random access memory (SRAM) and a dynamic random access memory (DRAM). The processor 210 may execute the embedded software by executing the software codes loaded in the memory 220 in order according to a control flow.

The embedded software which is distinct from a general-purpose operating system has the advantage in that certain tasks can be performed quickly and efficiently without an overhead and complexity of the general-purpose operating system. Accordingly, the embedded software is suitable for applications that require faster real-time responsiveness and/or lower power consumption.

In order to ensure the performance and reliability of the electronic device 200, the embedded software is required to function appropriately. Accordingly, it may be essential to detect defects in the software that may lead to errors in the electronic device 200 by testing the embedded software and correct the defects.

The analysis device 100 may test the embedded software of the electronic device 200. The analysis device 100 may include an analysis PC and an analysis server. The analysis device 100 may include a processor and a memory for executing various analysis tools such as a test tool 110 and a coverage analysis tool 120.

The analysis device 100 and the electronic device 200 may transmit and receive a signal using a predetermined or alternatively, desired interface 50. For example, when the electronic device 200 is an SSD, the analysis device 100 may provide a command to the electronic device 200 through an NVMe interface, and the electronic device 200 may provide a response to the analysis device 100 through the NVMe interface.

The analysis device 100 may generate a test scenario by executing the test tool 110 and provide commands to the electronic device 200 according to the test scenario. The electronic device 200 may execute software codes in response to the command of the analysis device 100. The analysis device 100 may analyze test results of the embedded software based on software code execution results of the electronic device 200.

For example, the analysis device 100 may analyze a test coverage by executing the coverage analysis tool 120 so as to analyze the test results of the software. The test coverage, which is an indicator of a degree to which the software has been tested, and may provide a quantitative evaluation of the completeness of a test. For example, the test coverage may include a statement coverage, a decision coverage, and a condition coverage.

The analysis device 100 may analyze a control flow based on the software codes and determine test positions according to the analyzed control flow. The analysis device 100 may control the electronic device 200 to execute the test scenario and analyze the test coverage according to whether the test positions have been executed under the test scenario. For example, the analysis device 100 may determine a test coverage value according to a proportion of executed test positions among all test positions.

If the analysis device 100 is able to analyze the test coverage during a runtime in which the electronic device 200 is tested, the analysis device 100 may detect a position that is not tested early and quickly correct the test scenario, thus reducing a time and costs of the software test.

However, since the embedded software may be designed to be improved or optimized and operated in limited resources of electronic device 200, an excessive overhead may be caused in electronic device 200 if an additional code is inserted to analyze a test coverage during a runtime. When the excessive overhead is caused in the electronic device 200, a test speed may be delayed, and an accurate test result may be difficult to obtain.

According to example embodiments of the present disclosure, the embedded software may be designed so that the electronic device 200 may allocate a coverage data region 222 distinguished from a software code region 221, to the memory 220. Furthermore, test positions are determined based on compiled instructions of the embedded software, and an instruction for marking the test coverage may be inserted into the test positions. The electronic device 200 may mark data indicating that the test position has been tested in the coverage data region 222 by executing the instructions of the software and executing the instructions for marking the test coverage in the test positions.

The analysis device 100 may request test coverage data stored in the coverage data region 222 from the electronic device 200 during the runtime of the electronic device 200. Furthermore, the analysis device 100 may analyze the test coverage using the data by executing the coverage analysis tool 120.

According to example embodiments of the present disclosure, a concise and improved or optimized test coverage marking instruction may be inserted on an instruction level other than a source code level. Furthermore, the electronic device 200 generates only raw data for a test coverage analysis during the runtime, and the analysis device 100 may obtain the raw data to analyze the test coverage. Accordingly, the test coverage may be analyzed during the runtime of the electronic device 200, and the overhead of the electronic device 200 for the test coverage analysis may be reduced or minimized at the same time.

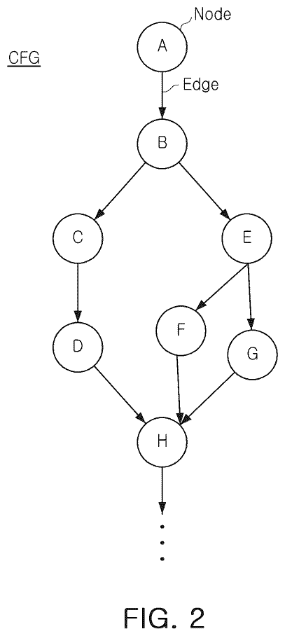

Hereinafter, a control flow of the software will be described in detail with reference to FIG. 2 before explaining an electronic device, a generation method for software code, and an analyzation method for a test coverage according to example embodiments of the present disclosure.

FIG. 2 is a view illustrating a control flow graph (CFG) of software.

The control flow graph (CFG) is a diagrammatic representation of an execution flow of software codes. In the control flow graph (CFG), basic blocks of software codes may be represented by nodes A to H. Each of the basic blocks may include a series of codes executed sequentially. In other words, the basic block may refer to a straight-line code sequence which has one entry point and one end point.

The control flow between the nodes A to H may be represented by edges. The control flow graph (CFG) may include branch nodes B and E from which control flows may diverge into two or more branches, or a join node H from which two or more control flows are merged into one.

The control flow graph (CFG) may be used to analyze and optimize software code. For example, test positions may be determined based on nodes in the control flow graph (CFG), and a test coverage may be determined based on a degree to which the test positions are tested. The achievement of the test may be determined based on the determined test coverage, and a test scenario may be improved such that untested codes may be tested.

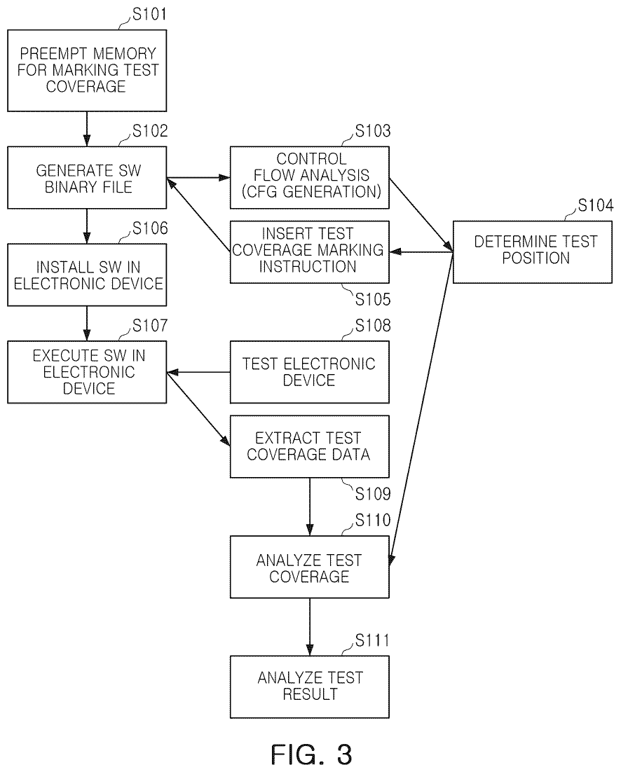

Hereinafter, an electronic device, a generation method for software code, and an analyzation method for a test coverage according to example embodiments of the present disclosure will be described in detail with reference to FIGS. 3 to 9.

FIG. 3 is a view illustrating an operation of an electronic system according to example embodiments of the present disclosure.

An operation of an electronic system according to example embodiments of the present disclosure may include an operation of generating and installing the software code of steps S101 to S106 in the electronic device, an operation of testing the electronic device of steps S107 and S108, and an operation of analyzing test results by analyzing a test coverage in steps S109 to S111.

In step S101, a region for storing test coverage data in the memory 220 of the electronic device 200 may be preempted. For example, a region having a predetermined or alternatively, desired size and address range may be assigned to the region for storing the test coverage data, a specification may be set so that the region is not used for other purposes, and software code may be written under a prescribed specification.

In step S102, a software binary file may be generated based on the software codes. For example, by compiling source codes constituting software, a binary file including binary codes consisting of ‘0’ and ‘1’ may be created.

In step S103, a control flow of the binary file may be analyzed. For example, in the binary codes, basic blocks and the control flow between the basic blocks may be determined, and a control flow graph (CFG) may be generated. A method of analyzing the control flow based on the binary file will be described below.

In step S104, test positions may be determined based on the control flow graph (CFG). For example, the basic blocks may be identified in the control flow graph (CFG), and the test positions may be determined in the basic blocks. Meanwhile, the determined test positions may be stored in the analysis device 100 and may be used for a test coverage analysis.

In operation S105, an instruction for marking a test coverage may be inserted into each of the determined test positions. For example, the control flow may be hooked in the test position, and a jump instruction may be inserted into the test position so that a test coverage marking instruction may be executed first instead of an original instruction, and the original instruction may be executed next.

The binary file may be corrected to insert an instruction in operation S105, and a final binary file may be generated in operation S102. On the other hand, since instructions for marking a test coverage are inserted by correcting already compiled binary files, the final binary file does not have to be recompiled. According to example embodiments, operations S102 to S105 may be repeatedly performed to correct the test positions.

In operation S106, software may be installed in the electronic device 200. For example, the software binary file may be provided to the electronic device 200 by the analysis device 100 and stored in a nonvolatile memory of the electronic device 200. Furthermore, in response to a software installation command from the analysis device 100, the software installation may be completed by committing the software binary file stored in the nonvolatile memory by the electronic device 200. Committing the software binary file may refer to an operation of verifying validity of the software binary file and allowing execution of the software.

In operation S107, software may be executed in the electronic device 200. For example, the electronic device may sequentially execute the software codes while moving an execution position according to a predetermined or alternatively, desired control flow.

In operation S108, the electronic device 200 may be tested by the analysis device 100. For example, the analysis device 100 may provide commands to the electronic device 200 based on a predetermined or alternatively, desired test scenario. The electronic device 200 may execute at least some software codes in response to the commands.

Meanwhile, when the execution position of the electronic device 200 reaches a predetermined or alternatively, desired test position, a test coverage marking instruction may be executed. In response to the test coverage marking instruction, the electronic device 200 may mark information indicating that the test position has been tested in the coverage data region 222.

In operation S109, test coverage data of the electronic device 200 may be extracted by the analysis device 100. For example, the analysis device 100 may obtain test coverage data of the coverage data region 222 using a command predefined for the electronic device 200.

In operation S110, a test coverage analysis based on the test coverage data may be performed by the analysis device 100. For the test coverage analysis, data of the test positions stored in operation S104 may be used. For example, the analysis device 100 may determine tested positions and untested positions among the test positions using the test coverage data and data from the test positions. Furthermore, the analysis device 100 may calculate a test coverage value based on a ratio of the tested positions among the test positions.

In operation S111, test results may be analyzed by the analysis device 100 based on test coverage analysis results.

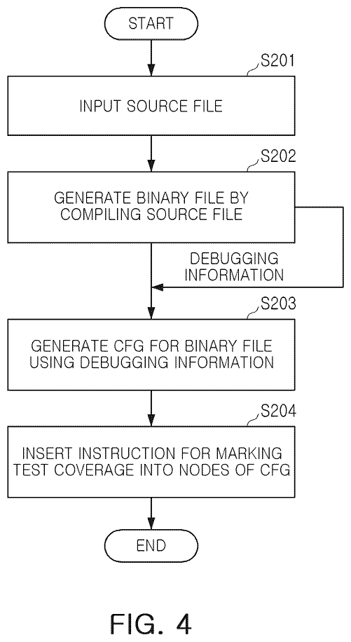

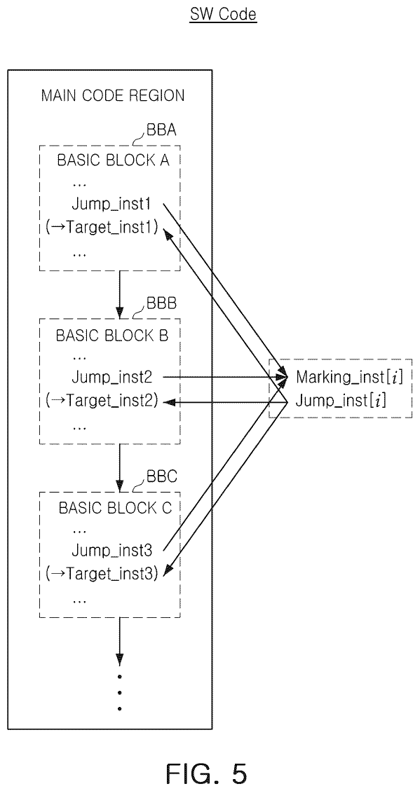

Hereinafter, a generation method for software code according to example embodiments of the present disclosure will be described in more detail with reference to FIGS. 4 and 5.

FIG. 4 is a flowchart illustrating a generation method for software code according to example embodiments of the present disclosure. FIG. 5 is a view illustrating software code generated according to example embodiments of the present disclosure.

Referring to FIG. 4, in operation S201, a software source file may be input to a compiler. The source file may include a plurality of source codes. The source codes may be written to comply with a prescribed specification. For example, the source codes may be written to comply with a specification that a region having a predetermined or alternatively, desired address range in the memory of the electronic device is allocated to store the test coverage data, and the region is not used for other purposes.

In operation S202, a binary file may be generated by compiling a software source file by a compiler. For example, the compiler may convert the source codes into low-level instructions by performing a syntax analysis of the source codes included in the source file, and may generate a binary file that may be executed on the electronic device by converting the instructions into the binary code.

The compiler may further generate debugging information associated with the binary file together with the binary file. The debugging information may indicate a relationship between a result of performing the syntax analysis on the source codes and the binary code. For example, the debugging information may include information indicating which bit numbers of the binary code each of the instructions corresponds to.

In operation S203, the control flow graph (CFG) for the binary file may be generated with reference to the debugging information. For example, the binary code may be converted into assembly instructions by being disassembled based on the debugging information. Control flows such as conditional statements and loops may be analyzed based on the instruments, and a control flow graph (CFG) may be generated based on the analyzed control flow.

In operation S204, an instruction for marking a test coverage may be inserted into nodes of the control flow graph (CFG). For example, one of the instructions included in a node may be determined as a target instruction, and an execution position of the target instruction may be determined as a test position. Since one node has one control flow, even if only one execution among the instructions included in the node is verified, it may be verified whether the remaining instructions have been performed or not.

As the binary code is corrected, the target instruction of the test position may be replaced with a jump instruction of jumping the execution position to a position of the test coverage marking instruction. When the test coverage marking instruction is executed, the target instruction of the test position may be recovered, and the binary code may be further corrected to revert the execution position to the test position.

Meanwhile, the test position may be selected from each of a plurality of nodes, but the present invention is not limited thereto. For example, in order to analyze a statement coverage based on a proportion of executed statements among all statements included in the binary code, the test positions may be determined in each of the basic blocks of the control flow graph (CFG). However, the present disclosure is not limited to determining a test position in all basic blocks, and the test positions may be determined in some of the basic blocks in order to analyze a condition coverage or a decision coverage.

The software code according to example embodiments of the present disclosure may include a main code and a marking code for marking a test coverage. Referring to FIG. 5, a main code region including a main code and a marking code region including a marking code are illustrated. The software may include binary codes, but in FIG. 5, pseudo instructions corresponding to the binary codes are illustrated.

The main code region may include a plurality of basic blocks BBA, BBB and BBC. For example, the basic blocks may correspond to nodes of the control flow graph (CFG) described with reference to FIG. 2. The plurality of basic blocks BBA, BBB, and BBC may be executed in order according to a control flow.

According to example embodiments of the present disclosure, one or more test coverage marking instructions may be inserted into the basic blocks. For example, a target instruction may be selected from a plurality of instructions included in each basic block, and a position of the target instruction may be determined as a test position. When the software execution position reaches the test position, information indicating that the test position has been tested may be marked through control flow hooking.

In an example of FIG. 5, the test position may be selected from each of the plurality of basic blocks BBA, BBB and BBC. By correcting the binary file, jump instructions Jump_inst1, Jump_inst2 and Jump_inst3 may be loaded to the test positions instead of the original target instructions. Target instructions Target_inst1, Target_inst2 and Target_inst3 may be stored in other regions.

The jump instructions may move a control flow in a main code to a marking code. For example, when the jump instruction is executed, a program counter pointing to a next address of the jump instruction may be moved to a marking instruction Marking_inst[i].

The marking instruction Marking_inst[i] may mark a memory position corresponding to the basic block in the coverage data region, depending on which basic block the control flow has moved from. For example, the coverage data region may include a coverage data bitmap having bits each corresponding to a different basic block. The marking instruction may indicate that the basic block has been executed by setting a bit corresponding to the basic block to “1” in the coverage data bitmap.

When the execution of the marking instruction is completed, the jump instruction of the test position may be restored to an original target instruction. Furthermore, in response to the jump instruction Jump_inst[i] following the marking instruction, the control flow may return to an original basic block, and the target instruction may be executed in the basic block.

Meanwhile, after an instruction for marking the test coverage is inserted into the test positions, metadata including a mapping information between the test positions and the memory positions included in the coverage data region may be generated in the analysis device 100 and stored in the analysis device 100. The metadata may be used to analyze which test positions have been tested by analyzing data stored in the coverage data region.

According to example embodiments of the present disclosure, instructions for marking the test coverage may be inserted into the binary code of the software. The electronic device 200 may generate information on which node has been tested, during a runtime, by performing the instructions, and the electronic device 200 does not directly analyze the test coverage during the runtime, thus reducing the overhead of the electronic device 200.

On the other hand, because the instruction for marking the test coverage is inserted on a binary level, additional compilation may not be required after inserting the instruction. Furthermore, as compared to a case of inserting the source code on a source level, improved or optimized instructions may be inserted into the electronic device with a limited memory, thereby further reducing the overhead for executing the instruction.

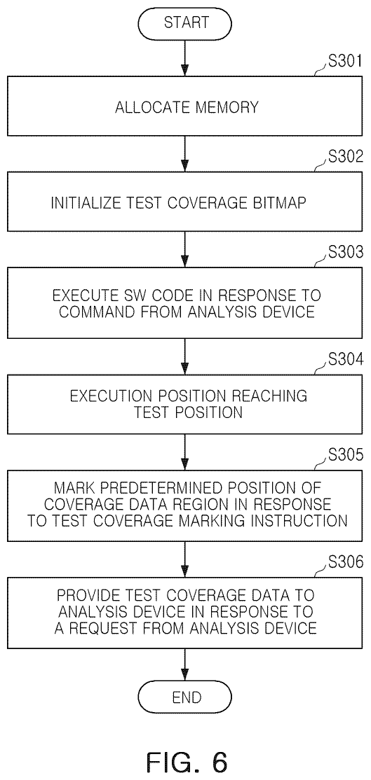

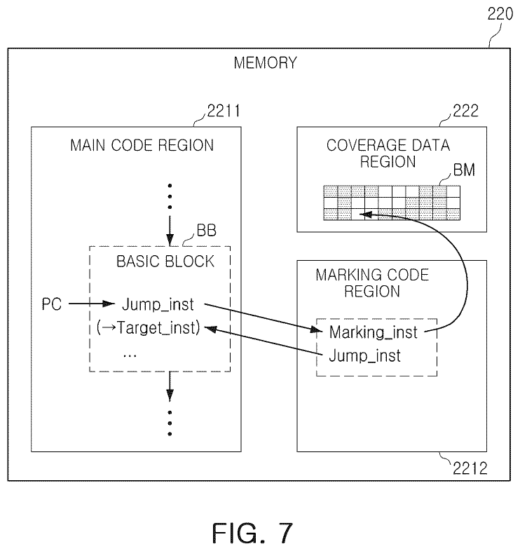

Hereinafter, a generation method of test coverage data by an electronic device according to example embodiments of the present disclosure will be described in detail with reference to FIGS. 6 to 7.

FIG. 6 is a flowchart illustrating an operation of an electronic device according to example embodiments of the present disclosure. FIG. 7 is a view illustrating an operation of an electronic device according to example embodiments of the present disclosure.

Referring to FIG. 6, in operation S301, the electronic device 200 may allocate a memory region for storing test coverage data. For example, when the electronic device 200 is initialized, software code may be loaded into the memory 220, and by executing the software code, a region having a predetermined or alternatively, desired address range of the memory 220 may be allocated to a coverage data region.

In operation S302, the electronic device 200 may initialize the allocated coverage data region. For example, when the coverage data region includes a test coverage bitmap, the electronic device 200 may initialize bits included in the test coverage bitmap to ‘0.’ An operation of operation S302 may be performed after the coverage data region is allocated. Furthermore, when the electronic device 200 supports a clear command that may allow the analysis device 100 to initialize the coverage data region, the operation of operation S302 may be performed in response to the clear command from the analysis device 100.

In operation S303, the electronic device 200 may execute the software code in response to a command from the analysis device 100. For example, the analysis device 100 may provide commands determined based on a test scenario to the electronic device 200. The electronic device 200 may process the commands by executing the software codes according to the control flow.

In operation S304, the execution position of the electronic device 200 may reach the test position. For example, whenever a command cycle is performed, the electronic device 200 may update a value of a program counter indicating an address of a next instruction to be executed at a current execution position. When the execution position reaches the test position, the electronic device 200 may update the program counter value so that the program counter points to a position in which the test coverage marking instruction is stored, in response to the jump instruction loaded to the test position.

In operation S305, the electronic device 200 may mark a memory position corresponding to the basic block in the coverage data region in response to a test coverage marking instruction. Furthermore, the electronic device 200 may revert the control flow to the target instruction of the basic block in response to the jump instruction following the test coverage marking instruction.

In operation S306, the electronic device 200 may provide the test coverage data to the analysis device 100 in response to a request from the analysis device 100. For example, the test coverage data may be a test coverage bitmap included in the coverage data region.

Referring to FIG. 7, the memory 220 may include a main code region 2211, a marking code region 2212, and a coverage data region 222. Main codes may be loaded to the main code region 2211, and a test coverage marking instruction may be loaded to the marking code region 2212.

The coverage data region 222 may include a test coverage bitmap BM. The test coverage bitmap BM may include a plurality of bits, and each of the plurality of bits may correspond to different test positions.

As described with reference to FIG. 5, the main codes may include the plurality of basic blocks. The plurality of basic blocks may be executed in order according to the control flow. FIG. 7 illustrates a basic block BB including a current execution position among the basic blocks.

When a program counter PC points to the test position according to the control flow, the jump instruction Jump_inst loaded to the test position may be executed in a next instruction cycle. In response to the execution of the jump instruction Jump_inst, a value of the program counter PC may be changed so that the program counter PC points to a marking instruction Marking_inst of the marking code region 2212. That is, the control flow may move from the test position of the basic block BB to the marking instruction Marking_inst. The electronic device 200 may mark a bit corresponding to the test position in the test coverage bitmap BM, in response to the marking instruction Marking_inst.

In an example of FIG. 7, cells displayed in the coverage data region shows data bits included in the test coverage bitmap BM. Each of the data bits may correspond to different basic blocks, and may indicate whether the corresponding basic blocks have been executed in the test. For example, a data bit value ‘1’ may indicate that the corresponding basic block has been executed, and the data bit value ‘0’ may indicate that the corresponding basic block has not been executed. In the example of FIG. 7, bits having the bit value ‘1’ are displayed as shading.

When the execution of the marking instruction Marking_inst is completed, the jump instruction Jump_inst of the test position may be restored to the target instruction Target_inst. Furthermore, in response to the jump instruction Jump_inst following the marking instruction Marking_inst, the control flow may move to the target instruction Target_inst of the basic block BB.

Meanwhile, the test coverage bitmap BM may be output to the analysis device 100 in response to the request from the analysis device 100. For example, a command of instructing data included in the coverage data region 222 to be output to the analysis device 100 may be defined between the analysis device 100 and the electronic device 200. The electronic device 200 may output the test coverage bitmap BM in response to the command.

According to example embodiments, a clear command for initializing each bit of the coverage data bitmap BM may be further supported between the analysis device 100 and the electronic device 200. The analysis device 100 may obtain the test coverage data in a desired test scenario while periodically requesting or initializing the coverage data bitmap (BM), and may analyze the test coverage using the obtained test coverage data.

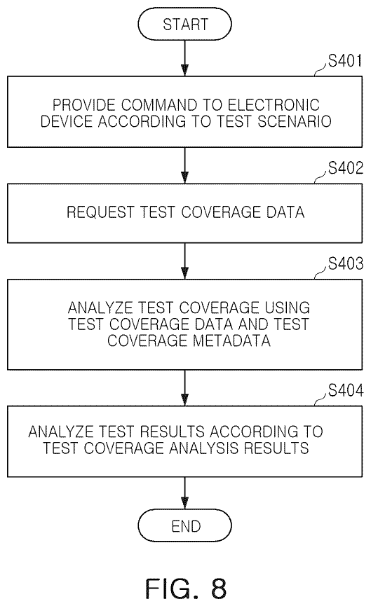

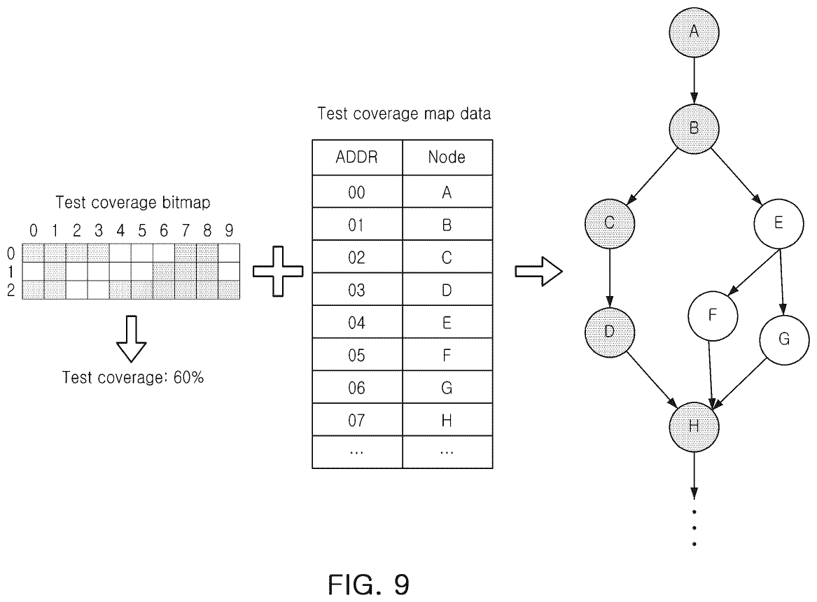

Hereinafter, an analyzation method for a test coverage according to example embodiments of the present disclosure will be described in detail with reference to FIGS. 8 and 9.

FIG. 8 is a flowchart illustrating an analyzation method for a test coverage according to example embodiments of the present disclosure. FIG. 9 is a view illustrating an analyzation method for a test coverage according to example embodiments of the present disclosure.

Referring to FIG. 8, in operation S401, the analysis device 100 may provide a command to the electronic device 200 according to the test scenario. For example, the analysis device 100 may test whether the electronic device 200 operates as intended by providing commands defined between the analysis device 100 and the electronic device 200, such as a read command and a write command, to the electronic device 200, according to a predetermined or alternatively, desired test scenario. Testing the software by executing the software according to the test scenario during the runtime of the electronic device 200 may be referred to as a dynamic test.

Not all software instructions are necessarily executed during the test of the electronic device 200. Depending on the test scenario of the electronic device 200, some instructions may be executed, and other instructions may not be executed. As more statements, conditions, and functions are executed in the test, the stability of the electronic device 200 in which the software is executed may be easily trusted. Accordingly, the analysis device 100 may analyze the test coverage by determining whether predetermined or alternatively, desired test positions have been executed, and may determine the degree of achievement of the test.

In operation S402, the analysis device 100 may request the test coverage data from the electronic device 200. As described above, the analysis device 100 may request the test coverage data from the electronic device 200 by providing the command to the electronic device 200, during the runtime at which the electronic device 200 is tested.

In operation S403, the analysis device 100 may analyze the test coverage using the test coverage data and the metadata of the test coverage data. For example, the test coverage data may be raw data in a bitmap format as described with reference to FIG. 7. The analysis device 100 may analyze the test coverage using the metadata describing raw data. An operation of analyzing the test coverage may include calculating a test coverage value or determining untested codes.

Referring to FIG. 9, it may be analyzed whether nodes in the control flow graph (CFG) have been tested, using a test coverage bitmap and test coverage metadata.

The test coverage bitmap output from the electronic device 200 may include binary data of ‘0’ or ‘1’ for each bit. The test coverage may be analyzed by interpreting the binary data using the metadata.

The metadata may include mapping information between bits of the test coverage bitmap and the test position. For example, the analysis device 100 may determine the test positions based on the control flow graph (CFG), may map each of the test positions to the bits of the test coverage bitmap, and may generate the metadata. In the metadata, the test positions may be displayed as information indicating which line of instruction is among instructions included in the software code. However, the present invention is not limited thereto, and the test positions may be represented by an identifier of the node of the control flow graph (CFG). FIG. 9 illustrates test coverage map data, which includes a mapping information between an address ADDR of bits of the test coverage bitmap and the identifier of the node.

The analysis device 100 may analyze which of a plurality of nodes having a test position has been tested by referring to the test coverage bitmap and the metadata. For example, the analysis device 100 may determine that a node A has been tested based on the fact that a ‘00’th bit value of the bitmap is ‘1’ and a ‘00’th bit of the bitmap corresponds to the node A of the control flow graph (CFG).

FIG. 9 illustrates a control flow graph (CFG) for analyzing whether each node has been tested based on the test coverage bitmap and the test coverage metadata. In the control flow graph (CFG) of FIG. 9, a shaded node represents a tested node, and an unshaded note represents an untested node.

A test coverage value may be calculated according to whether each test position has been tested in the control flow graph (CFG). In the example of FIG. 9, the test coverage value may be determined as a percentage of the number of bits having a value of ‘1’ among the bits of the test coverage bitmap. In accordance with what criteria the analysis device 100 determines the test positions based on, various test coverage values such as a statement coverage, a condition coverage, and a decision coverage may be calculated.

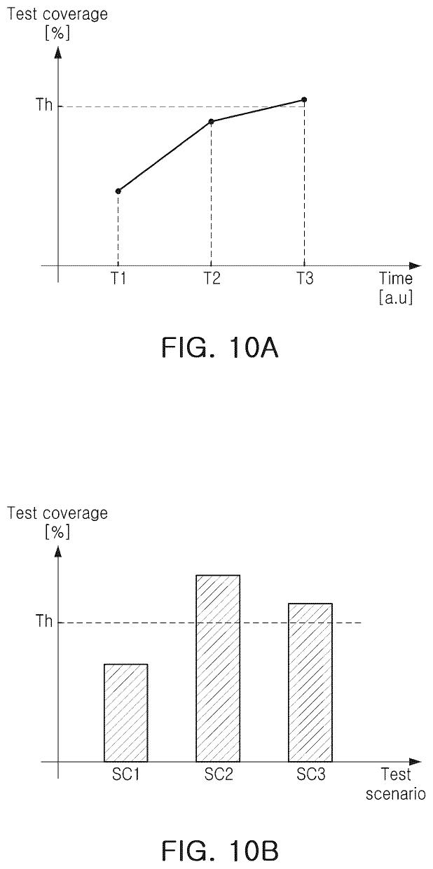

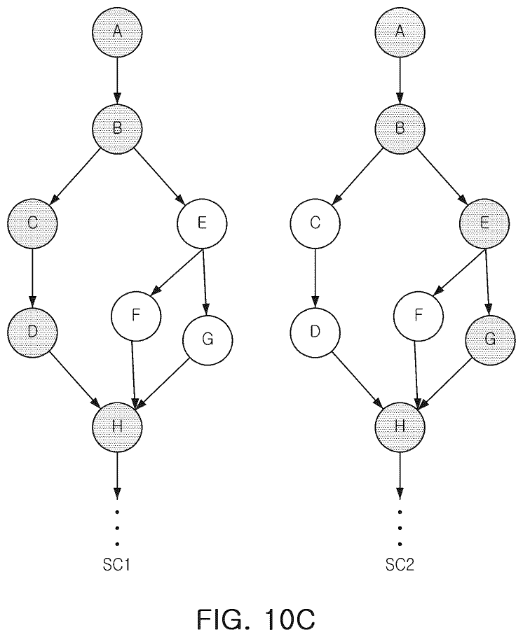

Referring back to FIG. 8, in operation S404, the analysis device 100 may analyze the test results according to the test coverage analysis results. An operation of analyzing the test results may be performed by determining the degree of achievement of the test based on the test coverage value and evaluating the quality of the test scenario. Hereinafter, various examples of analyzing test results with reference to FIGS. 10A to 10C will be described.

FIGS. 10A to 10C are views illustrating an analyzation method for a test result according to example embodiments of the present disclosure.

FIG. 10A is a graph illustrating a test coverage value over time. A horizontal axis of the graph represents time, and a vertical axis represents a test coverage value.

Referring to FIG. 10A, the analysis device 100 may periodically obtain the test coverage data from the electronic device 200 during the runtime of the electronic device 200. For example, the analysis device 100 may execute the test scenario, obtain the test coverage data from the electronic device 200 at first to third points (T1, T2 and T3) when the test scenario is executed, and calculate a test coverage value accumulated at each time point based on the obtained test coverage data. When the test coverage value exceeds a predetermined or alternatively, desired threshold value Th, the analysis device 100 may terminate the test of the electronic device 200.

According to example embodiments of the present disclosure, the analysis device 100 may calculate a test coverage value during the runtime of the electronic device 200, may determine that the electronic device 200 has been sufficiently tested when the test coverage value exceeds a threshold, and may stop testing the electronic device 200.

FIG. 10B is a graph illustrating test coverage values for each test scenario. The horizontal axis of the graph represents test scenarios SC1, SC2 and SC3, and the vertical axis represents a test coverage value.

Referring to FIG. 10B, test coverage values may be different for each test scenario. The analysis device 100 may determine a test scenario that needs to be improved, by detecting a test scenario in which the test coverage value is less than a threshold Th.

The analysis device 100 may analyze a test coverage of a first test scenario SC1 by performing a test according to the first test scenario SC1 during the runtime of the electronic device 200 and obtaining test coverage data from the electronic device 200. Furthermore, the analysis device 100 may analyze a test coverage of a second test scenario SC2 by initializing the test coverage data of the electronic device 200 using a clear command during the runtime of the electronic device 200 and performing a test according to the second test scenario SC2.

According to example embodiments of the present disclosure, the analysis device 100 may obtain test coverage in various test scenarios by obtaining and initializing test coverage data during the runtime of the electronic device 200. Accordingly, the ease of testing the electronic device 200 may be improved.

FIG. 10C illustrates nodes tested in the control flow graph (CFG) for each test scenario SC1 or SC2. In the control flow graph (CFG) of FIG. 10C, the tested nodes are displayed as shading.

Referring to FIG. 10C, the nodes to be tested may be different for each test scenario. For example, nodes C and D may be tested in the first test scenario SC1, but may not be tested in the second test scenario SC2. Meanwhile, a node F may not be tested in any of the first and second test scenarios SC1 and SC2. The analysis device 100 may determine the necessity of supplementing the test scenario by detecting a node that has not been tested in a plurality of test scenarios.

According to example embodiments of the present disclosure, instructions for marking data in which the test positions have been tested may be inserted into the test positions of the binary code of the software in order to test the software to be executed on the electronic device 200. Since the instructions are inserted directly into the binary code on an instruction level, improved or optimized instructions may be inserted in the electronic device 200 with limited system resources.

Furthermore, the electronic device 200 may only generate data indicating whether each of the test positions has been tested during the runtime, and the analysis device 100 may obtain and analyze the data from the electronic device 200. Accordingly, while the test coverage of the electronic device 200 may be analyzed during the runtime, the overhead of the electronic device 200 for the test coverage analysis may be reduced or minimized.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

What is claimed is:

1. An electronic device comprising:
a memory in which software code, including a plurality of test positions is loaded; and
a processor configured to execute the software code in order according to a control flow,
wherein the processor is configured to,
allocate a test coverage data region in the memory,
execute the software code based on a test scenario,
when an execution position reaches a target test position among the plurality of test positions, mark a memory position corresponding to the target test position in the test coverage data region in response to a test coverage marking instruction associated with the target test position, and
output test coverage data of the test coverage data region in response to an external command.

2. The electronic device of claim 1, wherein the target test position includes a jump instruction for moving the execution position to the test coverage marking instruction,
wherein the processor is configured to,
when the execution position reaches the test position, move the execution position to the test coverage marking instruction in response to the jump instruction,
execute the test coverage marking instruction,
restore the jump instruction to an original instruction of the target test position in response to completion of the execution of the test coverage marking instruction, and
reverting the execution position to the target test position.

3. The electronic device of claim 1, wherein the test coverage data region includes a plurality of bits corresponding to each of the plurality of test positions, and
wherein the processor is configured to,
mark the memory position by updating a bit value corresponding to the target test position in response to the test coverage marking instruction.

4. The electronic device of claim 1, wherein the processor is configured to,
initialize the test coverage data region in response to a clear command provided externally.

5. The electronic device of claim 1, wherein each of the plurality of test positions is included in different basic blocks of the software code.

6. A generation method for software code, the method comprising:
obtaining a source file instructing to allocate a determined region in a memory of an electronic device in which the software code is executed, to a test coverage data region;
generating a binary file by compiling the source file and generating debugging information associated with the binary file;
performing a control flow analysis on the binary file using the debugging information;
determining a test position for each of at least some of a plurality of basic blocks determined according to the control flow analysis; and
inserting an instruction of instructing a memory position corresponding to the test position to be marked in the test coverage data region, into the test position of the binary file.

7. The generation method for software code of claim 6, wherein the performing a control flow analysis comprises:
dividing instructions into basic blocks by performing a syntax analysis on the instructions included in the binary file, and generating a control flow graph in which the basic blocks are represented by nodes and a control flow between the basic blocks is represented by edges.

8. The generation method for software code of claim 6, wherein the debugging information indicates that which bit numbers of the binary file correspond to each of instructions included in the binary file.

9. The generation method for software code of claim 6, wherein the inserting an instruction into the test position comprises:
inserting an instruction of instructing a control flow to be hooked to a test coverage marking instruction, into the test position.

10. The generation method for software code of claim 6, wherein the inserting an instruction into the test position comprises:
replacing a target instruction of the test position with a jump instruction for moving an execution position to a position of a test coverage marking instruction; and
when the test coverage marking instruction is executed, inserting an instruction for restoring the target instruction to the test position, and reverting the execution position to the test position.

11. The generation method for software code of claim 6, further comprising:
storing metadata including a mapping information between a memory position corresponding to the test position in the test coverage data region and the test position.

12. The generation method for software code of claim 6, wherein the determining a test position comprises:
determining the test position in all of the plurality of basic blocks in order to analyze a statement coverage of the software code.

13. An analyzation method for a test coverage, the method comprising:
installing software code including a plurality of test positions determined based on control flow analysis and when a target test position among the plurality of test positions is executed, instructing to mark a memory position corresponding to the target test position in an allocated memory region, in an electronic device;
providing a command to the electronic device according to a test scenario;
obtaining test coverage data of the allocated memory region from the electronic device; and
analyzing a test coverage using the test coverage data and metadata indicating a mapping information between a plurality of memory positions of the test coverage data and the plurality of test positions.

14. The analyzation method for a test coverage of claim 13, wherein the obtaining test coverage data of the allocated memory region from the electronic device is performed periodically during a runtime of the electronic device, and
the analyzation method for a test coverage further comprises:
calculating a test coverage value during the runtime based on the test coverage data obtained periodically.

15. The analyzation method for a test coverage of claim 14, further comprising:
when the calculated test coverage value exceeds a threshold value, terminating a test according to the test scenario.

16. The analyzation method for a test coverage of claim 13, further comprising:
providing a clear command of instructing the test coverage data to be initialized, to the electronic device.

17. The analyzation method for a test coverage of claim 16, wherein the providing a clear command is performed whenever the analyzing a test coverage is terminated for one test scenario.

18. The analyzation method for a test coverage of claim 13, wherein the analyzing a test coverage comprises:
identifying tested positions and untested positions among the plurality of test positions; and
determining a ratio of tested positions among the plurality of test positions as a test coverage value.

19. The analyzation method for a test coverage of claim 13, wherein each of a plurality of basic blocks determined according to the control flow analysis includes a test position, and
the analyzing a test coverage comprises:
determining a ratio of tested positions among the plurality of test positions as a statement coverage value.

20. The analyzation method for a test coverage of claim 13, wherein the test coverage data includes a bitmap, and the metadata includes a mapping information between the plurality of bits and the plurality of test positions.
